(19) United States
(12) Patent Application Publication
(10) Pub. No.: US 2023/0405716 A1
(43) Pub. Date: Dec. 21, 2023

(54) PURGING ATTACHMENT AND METHOD FOR WORKING, IN PARTICULAR STRUCTURING, A SURFACE OF A WORKPIECE BY MEANS OF A LASER

(71) Applicant: Endress+Hauser SE+Co. KG, Maulburg (DE)

(72) Inventors: Simon Keßler, Steinen (DE); Dieter Senn, Zell (DE)

(21) Appl. No.: 18/252,205

(22) PCT Filed: Sep. 23, 2021
(86) PCT No.: PCT/EP2021/076263

§ 371 Date: May 9, 2023

(30) Foreign Application Priority Data
Nov. 9, 2020 (DE) 10 2020 129 495.6

(51) Int. Cl. B23K 26/142; B23K 26/352

(52) U.S. Cl. CPC B23K 26/142; B23K 2101/36; B23K 26/3584

(57) ABSTRACT

A purging attachment for a workpiece having a surface to be processed using laser radiation, wherein the workpiece has a chamber open on at least one side of the workpiece, and wherein the surface is within the chamber, comprises: a central opening through the purging attachment; a purge gas supply channel extending through the purging attachment to an outlet opening; a purge gas suction channel extending through the purging attachment to an inlet opening, wherein the outlet opening of the purge gas supply channel and the inlet opening of the purge gas suction channel are arranged on opposite sides of the central opening; and a centering portion configured to interact with a centering region arranged on the side of the workpiece such that the central opening, the outlet opening, and the inlet opening communicate with the chamber.

The invention relates to a purging attachment and to a method for processing, in particular structuring, a surface of a workpiece by means of a laser.

Material-removing methods can be used to structure surfaces of workpieces made of metals or metal alloys—for example, steel. A special case of structuring a surface is roughening the surface. Surfaces are roughened, for example, in order to allow better adhesion of a coating or to prepare a surface of a workpiece for adhering another component to the surface. Methods known in the prior art for structuring, in particular for roughening, a workpiece surface are blasting methods in which a granular or powdery blasting agent is blasted onto the surface to be processed. One example of such a method is sandblasting.

Instead of a particle beam, laser radiation can also be used for structuring or for roughening surfaces. For this purpose, a pulsed laser beam focused on the workpiece surface is used, which, locally, strongly heats the material of the workpiece and converts it into the molten phase. This results in the roughening of the irradiated surface.

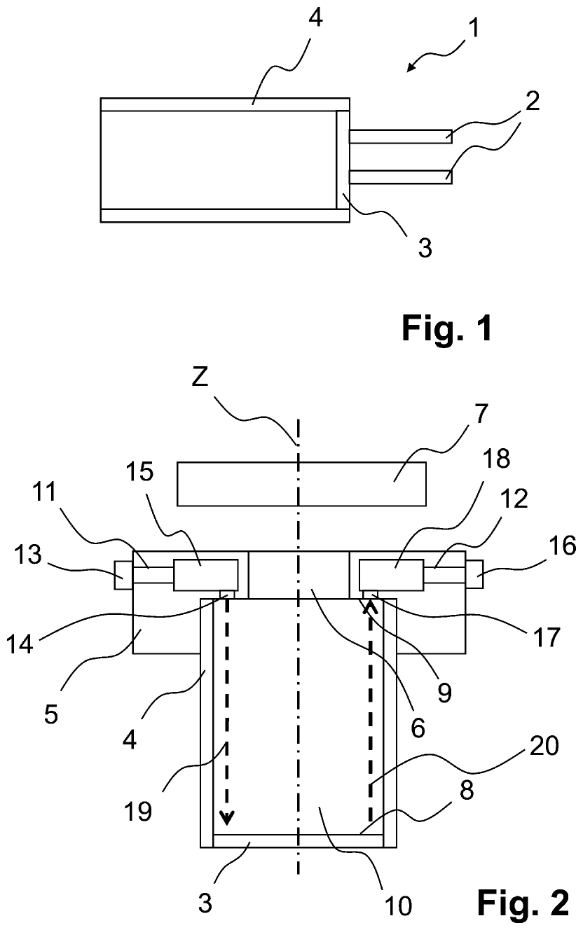

A technical challenge is the roughening of workpiece surfaces that are arranged in a depression or as an inner surface of a chamber, open on one side, inside the workpiece. An example of such a workpiece 1 is shown schematically in a longitudinal section in FIG. 1. This is a component of a vibronic sensor for detecting a measured variable of a medium, e.g., a fill-level or limit level, a viscosity, or a density, which vibronic sensor has an oscillating fork. The workpiece 1 comprises an oscillating fork having two oscillating elements 2, e.g., two metal rods or tines, which sit symmetrically on a membrane 3 made of metal. The circular disk-shaped membrane 3 is held in a tubular housing 4, also referred to as a tubular extension, in such a way that the membrane 3 closes the housing 4 on one side.

For the measurement, the oscillating elements 2 are made to oscillate, and the measured variable is detected in a known manner on the basis of a change in the resonance frequency and/or the amplitude of the oscillation. An electromechanical transducer unit is used to excite the oscillation. Said electromechanical transducer unit is bonded to the rear side of the membrane 3 during manufacture. To improve the adhesion, the rear side, i.e., the rear side 5, facing the inside of the housing 4, of the membrane 3, is first cleaned and roughened. For this purpose, one of the previously mentioned blasting methods is conventionally used.

In fact, during roughening, satisfactory results are achieved by means of blasting methods, in particular sandblasting. However, it is disadvantageous in this case that the workpiece 1 shown in FIG. 1 must be thoroughly cleaned after the sandblasting process to remove any particles remaining in the housing 4 and on the rear side of the membrane, e.g., by blowing out by means of compressed air, before the electromechanical transducer unit can be bonded to the rear side of the membrane. This requires manual processing steps and makes it difficult or impossible to automate the manufacturing process.

It is conceivable, in the manufacturing step of roughening the membrane rear side, to use a laser structuring method instead of the sandblasting method. However, even during the laser processing of the workpiece, soot, smoke, and undesired particles are formed that adhere to the workpiece or remain in the chamber surrounded by the housing. To avoid and/or remove such particles, suction devices or inert gas nozzles for purging are used in the prior art. For example, variable position gas nozzles that are used in laser welding processes are known.

DE 10 2006 040 784 A1 discloses a laser beam processing machine for the laser processing of a workpiece, which laser beam processing machine has dust discharge means for collecting and discharging dust that is formed by applying a laser beam to the workpiece. The dust discharge means comprise an air introduction chamber and a dust collection chamber as well as air supply means for supplying air to the air introduction chamber. Furthermore, the dust discharge means comprise eddy current generating means for generating an eddy current or flow in the dust collection chamber. The air introduction chamber and the dust collection chamber are surrounded by cover members that are mounted at the lower end of a condenser that is used to apply the laser beam to the workpiece.

Such devices known from the prior art can be used to remove and/or suction off particles produced during laser processing of a flat surface, but they are not well suited for use in the laser structuring of surfaces arranged within a chamber of a workpiece, such as, for example, the rear side of the membrane 3 of the workpiece 1 shown in FIG. 1, because conventional gas nozzles or suction devices arranged in the region of the laser optics cannot be brought close enough to the surface to be structured, and/or voluminous gas nozzles shade the laser radiation used for processing the rear side of the membrane. As a result, in the processing of such workpieces, not all contaminants and interfering particles can be reliably prevented or removed using conventional means during the laser processing.

The object of the invention is to provide an apparatus and a method that enable improved gas purging during laser processing of a workpiece having a surface to be processed that is arranged within a chamber that is open at least on one side of the workpiece.

This aim is achieved by the purging attachment according to claim 1 and the method according to claim 8. Advantageous embodiments are listed in the dependent claims.

The purging attachment according to the invention for a workpiece, having a chamber that is open on at least one side of the workpiece and a surface that is arranged within the chamber and is to be processed by means of laser radiation, comprises: a central opening through the purging attachment; at least one purge gas supply channel extending through the purging attachment and having at a first end a connector for a purge gas supply line and at a second end an outlet opening; at least one purge gas suction channel extending through the purging attachment and having at a first end a connector for a purge gas discharge line and at a second end an inlet opening, and wherein the outlet opening of the at least one purge gas supply channel and the inlet opening of the at least one purge gas suction channel are arranged on opposite sides of the central opening; and at least one centering portion that is configured to interact with a centering region arranged on the side of the workpiece such that the central opening, the outlet opening, and the inlet opening communicate with the chamber.

By arranging at least one or more purge gas supply channels having purge gas outlet openings and at least one or more purge gas suction channels having purge gas inlet openings in a purging attachment that can be placed onto the workpiece, which purge gas inlet openings communicate with the chamber within the workpiece when the purging attachment is placed on the workpiece, purge gas can be introduced into the chamber and/or suctioned out of the chamber without the purge gas flow being hindered by the wall of the workpiece. The inlet and outlet openings can also be arranged such that an accumulation of undesired particles and contaminants is prevented even in regions where edges are formed between the inner walls of the chambers. At the same time, the structure is compact, and allows the laser radiation for processing the surface to pass through the central opening, without purging or suction nozzles shading the laser beam.

In an advantageous embodiment, the outlet opening of the at least one purge gas supply channel and the inlet opening of the at least one purge gas suction channel can be configured as elongated holes.

The at least one purge gas supply channel can comprise a chamber that is formed within the purging attachment and communicates with the connector for the purge gas supply line and with the outlet opening. Likewise, the at least one purge gas suction channel can comprise a chamber that is formed within the purging attachment and communicates with the connector for the purge gas discharge line and with the outlet opening.

In a further, particularly advantageous embodiment, the purging attachment has two purge gas supply channels extending through the purging attachment and two purge gas suction channels extending through the purging attachment, wherein the purge gas supply channels each have at a first end a connector for a purge gas supply line and at a second end an outlet opening, wherein the purge gas suction channels each have at a first end a connector for a purge gas discharge line and at a second end an inlet opening, and wherein in each case a purge gas suction channel and a purge gas supply channel are arranged on opposite sides of the central opening, i.e., the inlet opening and the outlet opening are opposite each other in such a way that the central opening of the purging attachment is arranged between the inlet opening and the outlet opening.

In this embodiment, the purging attachment may have four chambers, e.g., of equal size, separated by partitions. The chambers can be arranged annularly around the central opening. Two of the chambers each form a component of a purge gas supply channel and, in this embodiment, communicate with a connector for a purge gas supply line and with an outlet opening. The two other chambers each form a component of a purge gas suction channel and, in this embodiment, communicate with a connector for a purge gas discharge line and an inlet opening. The chambers can in each case communicate with an outlet opening or an inlet opening, wherein in each case an outlet opening and an inlet opening are arranged on opposite sides of the central opening.

The connectors of the purge gas supply channels for a purge gas supply line can comprise a compressed air adapter. The connectors of the purge gas suction channels can also comprise a compressed air adapter. Compressed air adapters can be used to optionally supply channels with a gas overpressure, e.g., with air, or an inert protective gas such as argon or nitrogen, or, optionally, with a negative pressure for suctioning off gas. Therefore, if a channel is subjected to a gas overpressure, it is a purge gas supply channel, and, if it is subjected to a negative pressure, it is a purge gas suction channel.

Advantageously, the purging attachment can be annular, i.e., cylindrically symmetrical with respect to a longitudinal axis or cylinder axis running perpendicular to the central opening. In this embodiment, the purging attachment can comprise four, identically-sized, circular ring segment-shaped chambers, wherein each of the chambers communicates with an inlet opening or an outlet opening. In this embodiment, the inlet openings and the outlet openings are advantageously designed as elongated holes, the cross-section of which substantially has the shape of a circular ring segment. The circular ring segment-shaped arcs of the chambers and of the elongated holes can be arranged to be concentric to the cylinder axis of the central opening. Accordingly, in this embodiment, an imaginary circular ring extending through the cross-sections of all the elongated holes can be concentric to the central opening. Likewise, an imaginary circular ring extending through the circular ring segment-shaped chambers in a plane perpendicular to the cylinder axis of the central opening can be concentric to the central opening. This embodiment of the purging attachment is advantageous for the processing of an inner surface of a cylindrical housing chamber of a workpiece.

In one possible embodiment, the centering portion of the purging attachment can have a cylindrical surface that extends around a longitudinal axis of the central opening and is intended to rest against a contact surface of the workpiece, in order to center the workpiece with respect to the central opening of the purging attachment. In this embodiment, the contact surface corresponds to the previously mentioned centering region of the workpiece.

The central opening of the purging attachment can have a first cylindrically-symmetrical portion having a first cross-section and a second cylindrically-symmetrical section arranged coaxially behind the first cylindrically-symmetrical portion and having a second cross-section, wherein a radial shoulder is formed at the transition from the first portion to the second portion, which radial shoulder forms a stop surface for the workpiece when the purging attachment is placed on the workpiece.

In this embodiment, the outlet openings of all purge gas supply channels and the inlet openings of all purge gas suction channels can be arranged in the radial shoulder. In this way, the outlet openings and inlet openings are arranged in a space-saving manner in such a way that the fluid flow that forms between outlet openings and inlet openings flows through the chamber of the workpiece when the purging attachment is placed on the workpiece.

The method according to the invention for processing, in particular structuring, a surface of a workpiece by means of a laser comprises the following steps:
placing a purging attachment according to one of the embodiments described above onto the workpiece, wherein the workpiece has a chamber that is open on at least one first side of the workpiece such that the centering portion of the purging attachment interacts with a centering region of the workpiece arranged on the first side of the workpiece in such a way that the central opening of the purging attachment, the outlet opening of the at least one purge gas supply channel, and the inlet opening of the at least one purge gas suction channel of the purging attachment communicate with the chamber;
supplying gas to the chamber through the outlet opening of the at least one purge gas supply channel and suctioning gas through the inlet opening of the at least one purge gas suction channel; and
during the supply of gas into the chamber and during the suction of gas, beaming laser radiation through the central opening of the purging attachment onto a surface, arranged within the chamber, of the workpiece and processing the surface of the workpiece with the laser radiation.

The method according to the invention is suitable in particular for processing a workpiece for manufacturing a sensor for determining a process variable, e.g., a fill-level or limit level of a medium in a container, or for determining a density or viscosity of a medium, such as the workpiece shown in FIG. 1.

A method for producing a sensor for determining at least one process variable of a medium in a container can therefore comprise the following steps:
roughening a rear side of a membrane of an oscillatable unit, which has at least the membrane and at least one oscillating element arranged on a front side of the membrane opposite the rear side of the membrane, by means of the method according to the method described above;
adhering a control and receiving unit, which is designed to excite the mechanically oscillatable unit by means of an electrical excitation signal having an excitation frequency to oscillations in the oscillation mode corresponding to the excitation frequency and to receive the mechanical oscillations from the oscillatable unit and convert them to an electrical received signal, to the roughened rear side of the membrane; and
connecting the control and receiving unit to an electronics unit in such a way that the electronics unit and the control and receiving unit interact in order to generate, starting from the received signal, the excitation signal, and to determine the process variable from the received signal.

In the following, the invention is explained on the basis of the exemplary embodiments shown in the figures. The same reference signs refer to the same components of the parts shown in the figures. In the figures:

FIG. 1 is a schematic longitudinal section of a workpiece having a surface, to be processed by means of laser radiation, arranged within a chamber that is open on one side;

FIG. 2 is a schematic longitudinal section of an arrangement for processing a surface of the workpiece shown in FIG. 1 by means of laser radiation and for simultaneous suction of particles and contaminants with a purging attachment; and

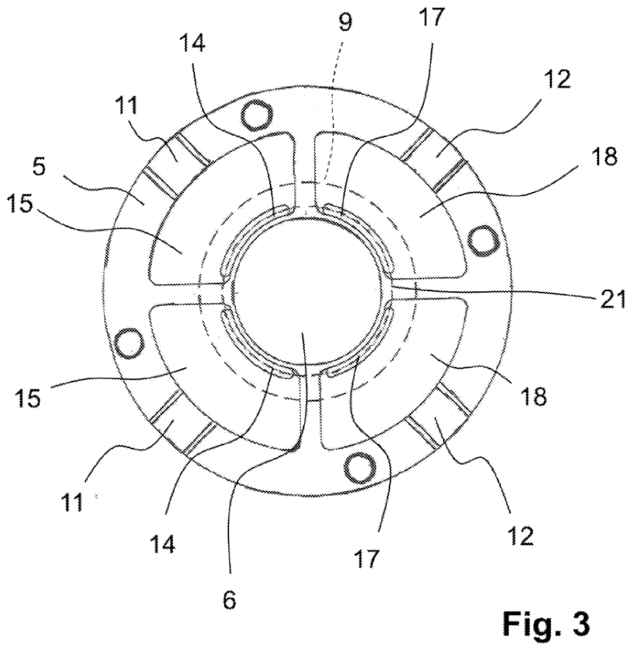

FIG. 3 is a schematic cross-section of the purging attachment shown in FIG. 2.

The laser processing for roughening a surface located within a chamber in a workpiece is described below based upon the processing of the rear side of a membrane in a method for producing a component for a sensor, as shown in FIG. 1 described in the introduction. However, the invention is also applicable to a plurality of other workpieces having a surface to be processed that is arranged in a depression or chamber open to at least one side.

FIG. 2 schematically shows an arrangement for laser structuring the rear side of the membrane 3 of the workpiece 1 shown in FIG. 1. A purging attachment 5, which has a central opening 6, is placed on the open side of the housing 4 of the workpiece. The purging attachment 5 is substantially annular, i.e., it has a cylindrical symmetry with respect to an imaginary cylindrical symmetry axis or cylinder axis Z. From the laser optics 7 of a laser processing machine, which are shown only schematically, laser radiation can pass through the central opening 6 to the surface 8 to be processed of the membrane 3, in order to structure or roughen the surface.

For the purging of the chamber 10, enclosed by the workpiece 1, with an inert gas, e.g., argon or nitrogen, the purging attachment 5 in each case has two purge gas supply channels 11 and two purge gas suction channels 12. In principle, a higher number of purge gas supply channels and purge gas suction channels is also possible, but it has been shown that a number of, in each, case two purge gas supply channels and two purge gas suction channels is particularly suitable for the specific geometry of the workpiece 1 used in the example described here.

In the longitudinal section of FIG. 2, only one purge gas supply channel 11 and one purge gas suction channel 12, which are arranged on opposite sides of the central opening 6, can be seen. At its first end, the purge gas supply channel 11 has a connector 13 in the form of a compressed air adapter. At its second end, the purge gas supply channel 11 has an outlet opening 14 that opens into the chamber 10. Furthermore, the purge gas supply channel 11 has a chamber 15 that communicates with the connector 13 and the outlet opening 14. The shape and function of the chamber 15 and the outlet opening 14 will be discussed in more detail further below in connection with FIG. 3.

With regard to its geometry, the purge gas suction channel 12 is designed to be entirely identical to the purge gas supply channel 11. It also has at a first end a connector 16, which connector can be designed as a compressed air adapter. At its second end, the purge gas suction channel 12 has an inlet opening 17. Furthermore, the purge gas suction channel 12 comprises a chamber 18 that communicates with the connector 16 and the inlet opening 17.

The central opening 6 of the purging attachment 5 has a first portion having a first diameter and an adjoining second portion having a second diameter, wherein the second diameter is greater than the first diameter. At the transition from the first portion to the second portion, as a result of the abrupt widening of the central opening 6 from the first diameter to the second diameter, a radial shoulder 9 is formed that has a circular ring surface facing the surface 8 to be processed. Said circular ring surface is used as a stop surface for the rear side of the housing 4 of the workpiece 1 when the purging attachment 5 is placed on the workpiece 1.

The second diameter of the central opening 6 in its second portion is adapted to the outer diameter of the cylindrical housing 4 such that the outer wall of the housing 4 abuts against the cylindrical wall, surrounding the central opening 6, of the purging attachment 5, when the purging attachment 5 is placed on the housing 4. In this way, the second portion of the central opening 6 forms a centering portion of the purging attachment 5, which is used to center the workpiece 1 with respect to the cylinder axis Z of the purging attachment 5, so that the cylindrical symmetry axis of the tubular housing 4 coincides with the cylinder axis Z.

The outlet opening 14 of the purge gas supply channel 11 and the inlet opening 17 of the purge gas suction channel 12 are arranged in the radial shoulder 9, specifically in a region of the circular ring surface of the radial shoulder 9, which is not covered by the wall of the housing 4 when the workpiece 1 is received in the second portion of the central opening 6 used as a centering portion of the purging attachment 5, so that the inlet and outlet openings 14, 17 communicate with the chamber 10, which is surrounded by the housing 4 and open towards the purging attachment 5. For this purpose, all inlet and outlet openings 14, 17 are arranged at a distance from the cylindrical inner wall of the second portion of the central opening 6, which is greater than the wall thickness of the hollow cylindrical housing portion, to be accommodated therein of the workpiece 1. By centering the workpiece 1 with respect to the central opening 6 by means of the centering portion of the purging attachment 5 such that the cylinder axes of the tubular housing 4 and the central opening 6 coincide, the inlet openings and the outlet openings of the purging attachment 5 are also arranged such that they inevitably open into the chamber 10 and are not covered by the housing wall of the housing 4.

The purge gas supply channel 11 is used to inject the purge gas into the chamber 10. For this purpose, the connector 13 can be connected to a purge gas source, e.g., a compressed air line or a gas cylinder, and can be pressurized with inert gas. In FIG. 2, the arrow 18 indicates the direction of the gas flowing into the chamber 10. The opposite purge gas suction channel 12 is used to extract gas from the chamber 10, which is indicated by the arrow 20 in FIG. 2. For this purpose, a vacuum can be applied to the connector 16—for example, by means of a pump. The blowing in and suctioning off of purge gas can take place alternately and/or simultaneously. It can advantageously be carried out simultaneously to the processing of the surface 8 by means of the laser.

FIG. 3 shows a cross-section perpendicular to the axis Z through the purging attachment 5 at the height of the chambers 15 and 18. Two purge gas supply channels 11 and two purge gas suction channels 12 can be seen, wherein one purge gas supply channel 11 and one purge gas suction channel 12 are each opposite one another. At its first end, each purge gas supply channel 11 has a connector (not shown in FIG. 3) for a purge gas supply line. Accordingly, each purge gas suction channel 12 also has a connector (likewise not shown in FIG. 3) for a purge gas discharge line. The purge gas supply channels 11 and the purge gas suction channels 12 each comprise a ring segment-shaped chamber 15 and 18, respectively. The chambers 15, 18 are separated from one another by partitions and arranged annularly around the central opening 6 of the purging attachment 5. The chambers 15, 18 each have an elongated hole, having a ring segment-shaped cross-section, on their bottom facing the second portion, which serves as a centering portion for the workpiece, of the central opening 6. These elongated holes form the outlet openings 14 of the purge gas supply channels 11 and the inlet openings 17 of the purge gas suction channels 12. The elongated holes are arranged along an imaginary circular line 21, the center point of which lies on the cylinder axis Z of the central opening 6 of the purging attachment 5. They are arranged in the radial shoulder 9 shown as dashed lines in FIG. 3, which is formed by the stepped cross-sectional widening of the central opening 6 between its first and second portions.

Experiments have shown that the ring segment-shaped configuration of the chambers 15 and and the configuration of the inlet and outlet openings 14, 17 as elongated holes cause a purge gas flow that is particularly favorable for the cleaning effect of the chamber 10 and in particular of the rear surface 8 of the membrane 3. In this arrangement, the inflowing gas (FIG. 2, arrow 19) largely flows along the inner tube wall of the housing 4, and thus reaches the surface 8 to be processed in a targeted manner. Accordingly, the gas is also suctioned off again in a targeted manner on the opposite side of the tube wall of the housing 4.

In the present exemplary embodiment, the purging attachment 5 is formed from a metal or a metal alloy—for example, from aluminum or stainless steel. Alternatively, it can also be formed from another material—for example, a plastic, and in particular a polymer. It can be composed of two parts, viz., a base body and a cover part. In FIG. 3, bores can be seen in the wall of the purging attachment into which fastening means, e.g., screws, can be inserted for such a cover part of the purging attachment.

For structuring, e.g., roughening, the surface 8 forming the rear side of the membrane 3, pulsed laser radiation can in a manner known per se be emitted from the laser optics 7 in the direction of the cylinder axis Z or at an acute angle to this axis. Soot or smoldering particles or other unwanted particles produced during the irradiation are simultaneously removed by supplying purge gas via the outlet openings 14 and suctioning off gas via the inlet openings 17. The method can in particular be carried out automatically by means of an electronically-controlled laser processing machine that is further configured to control the supply and suction of gas via the connectors 13 and 16 of the purging attachment 5.

In order to produce a sensor for determining a process variable such as the fill-level of a medium in a container, a density, or a viscosity, the rear side of a membrane of an oscillatable unit, which, in addition to the membrane, has at least one oscillating element arranged on the front side of the membrane, e.g., an oscillating fork or a single oscillatable rod, can be roughened according to the method described. Subsequently, a control and receiving unit, which comprises, for example, an electromechanical converter unit, such as a piezoelectric drive or an electromagnetic drive, can be bonded to the roughened rear side of the membrane. To produce the sensor, the control and receiving unit can be further connected to an electronics unit such that the electronics unit and the control and receiving unit can interact in order to cause the oscillatable unit to oscillate or to receive mechanical oscillations from the oscillatable unit and convert them into an electrical signal.

A plurality of further modifications of the invention described herein are conceivable. For example, the purge gas attachment can have a higher or lower number of purge gas supply and suction channels. It is also possible for the workpiece, and therefore the purge gas attachment, to differ from the cylindrical symmetry of the embodiment described in detail herein.

1-9. (canceled)

10. A purging attachment for a workpiece having a surface to be processed using a laser radiation, wherein the workpiece includes a workpiece chamber open on at least one side of the workpiece, and wherein the surface to be processed is disposed within the workpiece chamber, the purging attachment comprising:
a central opening through the purging attachment;
at least one purge gas supply channel extending through the purging attachment and including, at a first end, a supply connector configured for a purge gas supply line and, at a second end, an outlet opening;
at least one purge gas suction channel extending through the purging attachment and including, at a first end, a discharge connector configured for a purge gas discharge line and, at a second end, an inlet opening, wherein the outlet opening of the at least one purge gas supply channel and the inlet opening of the at least one purge gas suction channel are disposed on opposite sides of the central opening; and
at least one centering portion configured to interact with a centering region of the workpiece arranged on the side of the workpiece such that the central opening, the outlet opening, and the inlet opening communicate with the workpiece chamber.

11. The purging attachment of claim 1, wherein the outlet opening of the at least one purge gas supply channel and the inlet opening of the at least one purge gas suction channel are configured as elongated holes.

12. The purging attachment of claim 1, wherein the at least one purge gas supply channel comprises a supply chamber within the purging attachment in communication with the supply connector and with the inlet opening, and wherein the at least one purge gas suction channel comprises a suction chamber the purging attachment in communication with the discharge connector and with the outlet opening.

13. The purging attachment of claim 1, wherein:
the at least one purge gas supply channel includes two purge gas supply channels extending through the purging attachment, including corresponding supply connectors and outlet openings at respective first and second ends;
the at least one purge gas suction channel includes two purge gas suction channels extending through the purging attachment, including corresponding discharge connectors and inlet openings at respective first and second ends;
wherein the purge gas suction channels are disposed opposite and the purge gas supply channels on opposing sides of the central opening.

14. The purging attachment of claim 1, wherein the centering portion includes a cylindrical surface that extends around a longitudinal axis of the central opening and is configured to seat against a contact surface of the workpiece as to center the workpiece with respect to the central opening of the purging attachment.

15. The purging attachment of claim 1, wherein the central opening of the purging attachment includes a cylindrically symmetrical first portion having a first cross-section and a cylindrically symmetrical second portion arranged coaxially behind the first cylindrically-symmetrical portion and having a second cross-section,
wherein a radial shoulder is formed at a transition from the first portion to the second portion, which radial shoulder forms a stop surface configured for the workpiece when the purging attachment is arranged on the workpiece in operation.

16. The purging attachment of claim 6, wherein the outlet opening of the at least one gas supply channel and the inlet opening of the at least one purge gas suction channel are arranged in the radial shoulder.

17. A method for structuring a surface of a workpiece using a laser, the method comprising:
positioning a purging attachment according to claim 1 onto the workpiece;
supplying gas to the workpiece chamber through the outlet opening of the at least one purge gas supply channel and suctioning the gas, and particles from the workpiece chamber entrained in the gas, through the inlet opening of the at least one purge gas suction channel; and
during the supply of gas into the workpiece chamber and during the suction of gas and particles, beaming laser radiation generated by the laser through the central opening of the purging attachment onto the surface to be processed as to roughening the surface via the laser radiation.

18. A method for producing a sensor for determining at least one process variable of a medium in a container, the method comprising:
roughening a rear side of a membrane of a mechanically oscillatable unit, which includes the membrane and at least one oscillating element disposed on a front side of the membrane opposite the rear side of the membrane, using the method according to claim 17;
adhering a control-receiving unit to the roughened rear side of the membrane, which control-receiving unit is configured to excite the oscillatable unit, via an electrical excitation signal having an excitation frequency, to mechanical oscillations in an oscillation mode corresponding to the excitation frequency, to receive the mechanical oscillations from the oscillatable unit, and to convert the mechanical oscillations to an electrical received signal; and
connecting the control-receiving unit to an electronics unit such that the electronics unit and the control-receiving unit interact as to generate, starting from the received signal, the excitation signal, and to determine the process variable from the received signal.
